(19) United States
(12) Patent Application Publication
(10) Pub. No.: US 2006/0277560 A1
(43) Pub. Date: Dec. 7, 2006

(54) Objective lens actuator

(75) Inventors: Jin-Bo Qiu, Shenzhen (CN); Jing-Wei Su, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/446,921

(22) Filed: Jun. 5, 2006

(30) Foreign Application Priority Data
Jun. 4, 2005 (CN) 200510035158.3

(51) Int. Cl. G11B 7/00

(52) U.S. Cl. 720/681

(57) ABSTRACT

An objective lens actuator includes a base, a suspension apparatus mounted on the base, a holder for holding an objective lens, the holder suspended by the suspension apparatus, and a voice coil motor (VCM) driving the holder to vibrate, wherein the VCM comprises a pair of U-shaped yokes, one sidewall of each of the yokes is defined an aperture in a center. The objective lens actuator can form a uniform magnetic field so that it can have a very precision of focusing the laser light at a correct track. That is to say a pickup having the objective lens actuator can very accurately write or read information of memories.

### BACKGROUND

1. Field of the Invention

The present invention relates to optical pickup apparatuses, and particularly to an objective lens actuator.

2. General Background

Generally, an objective lens actuator of an optical pickup apparatus includes a base, a suspension mounted to the base, a lens holder for holding objective lens, a Voice Coil Motor (VCM) driving the lens holder, a pair of U-shaped yokes mounted to the base, a pair of permanent magnets respectively mounted to the pair of yokes. When a current flows through the VCM, the VCM vibrates in the magnetic field formed by the pair of permanent magnet. The lens holder driven by the VCM also vibrates to precisely focusing a laser light through the objective lens at a correct track so that information of memories may be accurately to be written or read. Thus, preserving capability of precisely focusing at the correct track is a key point in the design of an objective actuator. Equilibrium of the magnetic field is an important thing for maintaining the capability of precisely focusing at the correct track. However, because the yokes are U-shaped, magnetic flux density of bottom areas within the yokes is greater than that of top areas within the yokes. Thus, the magnetic field within the yokes is uniform.

What is needed is to provide an objective lens actuator in which the magnet can form an uniform magnetic field.

### SUMMARY

An objective lens actuator includes a base, a suspension apparatus mounted on the base, a holder for holding an objective lens, the holder suspended by the suspension apparatus, and a voice coil motor (VCM) driving the holder to vibrate, wherein the VCM comprises a pair of U-shaped yokes, one sidewall of each of the yokes is defined an aperture in a center.

Other advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of an objective lens actuator in accordance with a preferred embodiment of the present invention, the objective lens actuator includes an objective lens; and

FIG. 2 is an assembled view of the FIG. 1.

### DETAILED DESCRIPTION OF THE EMBODIMENT

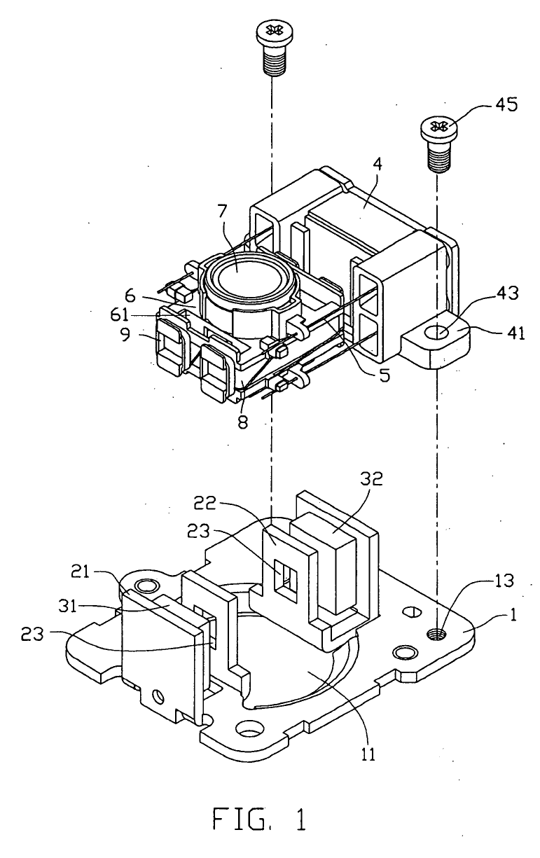

Referring to FIG. 1, an objective lens actuator of an optical pickup apparatus in accordance with a preferred embodiment of the present invention includes a base 1, a pair of yokes 21, 22, a pair of magnet 31, 32, a fixture 4, four wires 5 one end of which are fixed to the fixture 4, a holder 6 suspended on the other end of the four wires 5, a focusing coils 8, and four tracking coils 9.

The base 1 defines a loophole 11 in the center, and two threaded holes 13 in a same end. The yokes 21 and 22 are U-shaped. The yoke 22 is located between the threaded holes 13. The yokes 21 and 22 mutually opposite protrudes upwardly from the base 1 on sides of the loophole 11. A magnet 31 is received in the yoke 21 and mounted to an inner sidewall of the yoke 21 away from the loophole 11. A magnet 32 is received in the yoke 22 and mounted to an inner sidewall of the yoke 22 away from the loophole 11. North poles of the magnets 31 and 32 face a center of the loophole 11. Each of the other sidewalls of the yokes 21 and 22 adjacent to the loophole 11 define an aperture 23.

The holder 6 defines a circular through hole (not shown in the FIGS.) thereof for holding an objective lens 7 therein. Two slots 61 are defined in the holder 6 respectively for the other sidewall of each of the yokes 21 and 22 passing there through. The focusing coil 8 circles around the holder 6, and is electrically connected to the wires 5. Two of the tracking coils 9 straddle one side of the holder 6, and the other two of the tracking coils 9 straddle the other opposite side of the holder 6. The tracking coils 9 are electrically connected to the wires 5 as well.

A top surface of the focusing coil 8 is located is perpendicular to an optical axis of the objective lens 7. The tracking coils 9 are mounted on a same plane parallel to the optical axis of the objective lens 7.

The fixture 4 includes a pair of fixing portions 41 extending from opposite sides thereof. Each fixing portion 41 defines a locking hole 43, corresponding to a corresponding treaded hole 13 of the base 1.

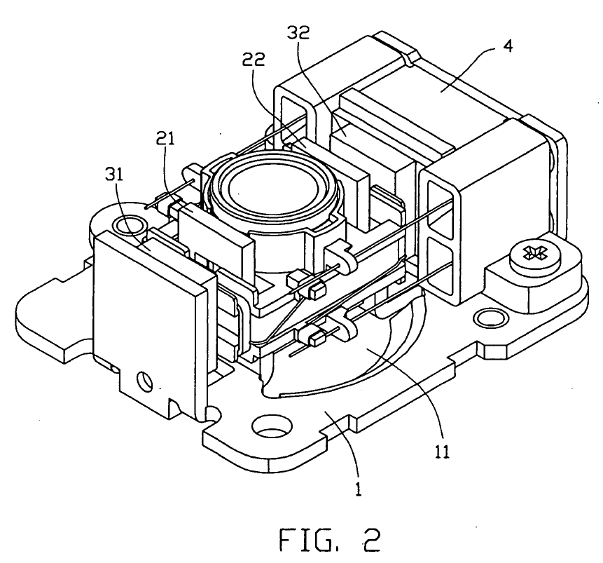

Referring to the FIG. 2, in assembly, the locking holes 43 of the fixture 4 align with the threaded holes 13 of the base 1. Screws 45 are inserted through the locking holes 43 to be engaged in the threaded holes 13. The sidewalls of the yokes 21 and 22 adjacent the loophole 11 of the base 1 is respectively received into the slots 61 of the holder 6. Then the objective lens 7 is suspended above the loophole 11 of the base 11 via the wires 5. Light passes through the loophole 11 to shine on the objective lens 7. Thus, the combined assembly of the fixture 4, the wires 5, the holder 6, the objective lens 7, the focusing coil 8, the tracking coils 9 is mounted to the base 1. The yokes 21 and 22, the magnets 31 and 32, the focusing coil 8, and the tracking coils 9 form a voice coil motor (VCM). The fixture 4 and the wires 5 form a suspension apparatus.

When a current flows through the focusing coil 8, a Lorentz force acts on the focusing coil 8 parallel to the optical axis of the objective lens 7. Thus, the focusing coil 8 drives the holder 6 to move along the optical axis of the objective lens 7. When a current flows through the tracking coils 9, a Lorentz force acts on the tracking coils 9 are stressed is perpendicular to the optical axis of the objective lens 7. Thus, the tracking coils 9 drive the holder 6 to move toward or away from the fixture 4.

In the illustrated embodiment, in the U-shaped pairs 21 and 22, magnetic flux density of bottom areas within the first parts 21 and 22 is greater than that of top areas within the yokes 21 and 22. However, because the aperture 23 has a low magnetic permeability there, the aperture 23 decreases magnetic flux density there. That is to say the magnets 31 and 32 mounted in the yokes 21 and 22 can provide a uniform magnetic field. According to the Lorentz Law, a Lorentz force is direct ratio to magnetic flux density of the magnetic field. If the magnetic flux density is uniform, the Lorentz force that the focusing coil 8 and the tracking coils 9 are stressed is uniform as well. A uniform Lorentz force can improve very more precision of the objective lens 7 focusing the laser light at a correct track. Thus, information of memories may be accurately to be written or read.

Alternatively, the aperture 23 can be filled with materials having a low magnetic permeability.

It is believed that the present embodiments and its advantages will be understood from the foregoing description, and it will be apparent that various changes may be made thereto without departing from the spirit and scope of the invention or sacrificing all of their material advantages, the examples hereinbefore described merely being preferred or exemplary embodiments of the invention.

We claim:

1. An objective lens actuator comprising:
a base;
a suspension apparatus mounted on the base;
a holder for holding an objective lens, the holder suspended by the suspension apparatus; and
a voice coil motor (VCM) driving the holder to vibrate, wherein the VCM comprises a pair of U-shaped yokes, one sidewall of each of the yokes defines an aperture in a center.

2. The objective lens actuator as claimed in claim 1, wherein the VCM further comprises a pair of magnets received in the yokes, a focusing coil circles around the holder, a plurality of tracking coils respectively straddle two opposite sides of the holder, and the focusing coil and the tracking coils are electrically connected to the wires.

3. The objective lens actuator as claimed in claim 2, wherein the magnets are respectively mounted on the other sidewall of each of the yokes.

4. The objective lens actuator as claimed in claim 1, wherein the suspension apparatus comprises a fixture and four wires, the fixture is mounted on the base, one end of each of the four wires is fixed to the fixture, the other end of each of the four wires is fixed to the holder.

5. The objective lens actuator as claimed in claim 1, wherein the base defines a loophole in a center there light passing through.

6. An objective lens actuator comprising:
a base;
a suspension apparatus mounted on the base;
a holder for holding an objective lens, the holder suspended by the suspension apparatus; and
a voice coil motor (VCM) driving the holder to vibrate, wherein the VCM comprises a pair of U-shaped yokes, one sidewall of each of the yokes defines an aperture in a center, and the aperture is filled with materials having a low magnetic permeability.

7. The objective lens actuator as claimed in claim 6, wherein the VCM further comprises a pair of magnet received in the yokes, a focusing coil circles around the holder, a plurality of tracking coils respectively straddle two opposite side of the holder, and the focusing coil and the tracking coils are electrically connected to the wires.

8. The objective lens actuator as claimed in claim 7, wherein the magnets are respectively mounted on the other sidewall of each of the yokes.

9. The objective lens actuator as claimed in claim 6, wherein the suspension apparatus comprises a fixture and four wires, the fixture is mounted on the base, one end of each of the four wires is fixed to the fixture, the other end of each of the four wires is fixed to the holder.

10. The objective lens actuator as claimed in claim 6, wherein the base defines a loophole in a center there a light passing through.

11. An optical apparatus comprising:
first means for performing image-pickup function of said optical apparatus installable in said optical apparatus; and
an objective lens installable in said optical apparatus next to said first means, said objective lens transmitting light therethrough between said first means and a target of said optical apparatus; and
an actuator installable beside said objective lens to adjustably control a relative location of said objective lens in said optical apparatus, said actuator comprising a voice coil motor (VCM) having a U-shaped yoke contributing to generation of a magnetic field in said VCM and a second means formed at said yoke for lowering magnetic permeability of a part of said yoke.

12. The optical apparatus as claimed in claim 11, wherein said second means is an aperture formed at a sidewall of said yoke.
